(19) United States
(12) Patent Application Publication
(10) Pub. No.: US 2023/0336966 A1
(43) Pub. Date: Oct. 19, 2023

(54) METHOD AND APPARATUS FOR CONTROLLING COMMUNICATION OF PLURALITY OF DEVICES BELONGING TO COMMUNICATION GROUP

(71) Applicant: Samsung Electronics Co., Ltd., Suwon-si (KR)

(72) Inventor: Michal WODCZAK, Warsaw (PL)

(21) Appl. No.: 18/340,557

(22) Filed: Jun. 23, 2023

Related U.S. Application Data
(63) Continuation of application No. PCT/KR2021/019335, filed on Dec. 17, 2021.

(30) Foreign Application Priority Data
Dec. 31, 2020 (KR) 10-2020-0189711

(51) Int. Cl. H04W 8/02; H04W 4/08; H04L 27/00

(52) U.S. Cl. CPC H04W 8/02; H04W 4/08; H04L 27/0012; H04L 12/1403

(57) ABSTRACT

A method of controlling communication of a plurality of devices belonging to a communication group in a wireless communication system is provided. The method includes requesting generation of the communication group, receiving, from a distributed artificial intelligence entity, information about terminals that are to perform cooperative transmission among the plurality of terminals included in the communication group, identifying, based on the information about the terminals that are to perform the cooperative transmission, the terminals that are to perform the cooperative transmission and modulation methods to be requested for the terminals that are to perform the cooperative transmission, respectively, for the cooperative transmission, and requesting the terminals that are to perform the cooperative transmission, to perform data modulation according to the identified modulation methods, respectively.

### CROSS-REFERENCE TO RELATED APPLICATION(S)

This application is a continuation application, claiming priority under § 365(c), of an International application No. PCT/KR2021/019335, filed Dec. 17, 2021, which is based on and claims the benefit of a Korean patent application number 10-2020-0189711, filed on Dec. 31, 2020, in the Korean Intellectual Property Office, the disclosure of which is incorporated by reference herein in its entirety.

### BACKGROUND

### 1. Field

The disclosure relates to a method and apparatus for controlling communication of a plurality of devices belonging to a communication group in a wireless communication system.

### 2. Description of Related Art

To meet the increased demand with respect to wireless data traffic since deployment of 4th generation (4G) communication systems, efforts have been made to develop an improved 5th generation (5G) or pre-5G communication system. For this reason, the 5G or pre-5G communication system is also called ‘beyond 4G network’ or ‘post long-term Evolution (LTE) System’. The 5G communication system is considered to be implemented in ultra-high frequency (millimeter (mm)Wave) bands, (e.g., 60 gigahertz (GHz) bands), so as to accomplish higher data rates. In order to mitigate path loss of radio waves and increase a propagation distance of radio waves in an ultra-high frequency band, beamforming, massive multiple-input and multiple-output (MIMO), full-dimensional MIMO (FD-MIMO), array antenna, analog beamforming, and large-scale antenna technologies have been discussed in relation to 5G communication systems. In addition, in order to improve a network of a 5G communication system, technologies, such as evolved small cells, advanced small cells, cloud radio access networks (cloud RANs), ultra-dense networks, device-to-device (D2D) communication, wireless backhaul, moving networks, cooperative communication, coordinated multi-points (CoMP), and received-interference cancelation, have been developed. In addition, for 5G communication systems, hybrid frequency shift keying (FSK) and quadrature amplitude modulation (QAM) (FQAM) and sliding window superposition coding (SWSC), which are advanced coding modulation (ACM) schemes, and filter bank multi-carrier (FBMC), non-orthogonal multiple access (NOMA), and sparse code multiple access (SCMA), which are advanced access technologies, have been developed.

The Internet has evolved from a human-centered connection network, through which humans generate and consume information, to an Internet-of-things (IoT) network that exchanges and processes information between distributed elements, such as objects. Internet-of-everything (IoE) technology in which IoT technology is combined with big data processing technology via connection with a cloud server or the like has also emerged. In order to implement IoT, technical factors, such as detection technology, wired/wireless communication, network infrastructure, service-interface technology, and security technology are required, and research on technologies, such as a sensor network, machine-to-machine (M2M) communication, machine-type communication (MTC), and the like for connection between objects has recently been conducted. In an IoT environment, via collection and analysis of data generated from connected objects, an intelligent Internet technology (IT) service to create new value for peoples' lives may be provided. IoT may be applied to various fields, such as smart homes, smart buildings, smart cities, smart cars or connected cars, smart grids, health care, smart home appliances, or high-tech medical services, via the convergence and combination of existing information technology (IT) and various industries.

Accordingly, various attempts are being made to apply 5G communication systems to IoT networks. For example, technologies, such as a sensor network, M2M communication, and MTC are implemented by beamforming, MIMO, or array antenna schemes. The application of cloud RAN as the big data processing technology described above may be an example of convergence of 5G communication technology and IoT technology.

Communication using vehicles (hereinafter, referred to as vehicle-to-everything (V2X)) in 5G communication systems, such as vehicle-to-vehicle, vehicle-to-terminal, or vehicle-to-structure communication, is being researched, and it is expected that various services using V2X may be provided to users.

The above information is provided as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for controlling communication of a plurality of devices belonging to a communication group in a wireless communication system.

Additional aspects will be set forth in part in the description which follows and, in part, will be apparent from the description, or may be learned by practice of the presented embodiments.

In accordance with an aspect of the disclosure, a method, performed by an access and mobility management function (AMF), of controlling communication of a plurality of devices belonging to a communication group in a wireless communication system is provided. The method includes requesting generation of the communication group, receiving, from a distributed artificial intelligence entity, information about terminals that are to perform cooperative transmission among the plurality of terminals included in the communication group, identifying, based on the information about the terminals to perform the cooperative transmission, the terminals to perform the cooperative transmission and modulation methods to be requested for the terminals to perform the cooperative transmission, respectively, for the cooperative transmission, and requesting the terminals to perform the cooperative transmission, to perform data modulation according to the identified modulation methods, respectively.

In accordance with another aspect of the disclosure, the method of controlling communication of a plurality of devices belonging to a communication group further includes invoking the distributed artificial intelligence entity, requesting, from the distributed artificial intelligence entity, information about a code matrix to be used for the cooperative transmission, and receiving, from the distributed artificial intelligence entity, the information about the code matrix indicating the number of terminals to perform the cooperative transmission.

In accordance with another aspect of the disclosure, the code matrix includes a space-time block code (STBC) matrix, the identifying, based on the information about the terminals to perform the cooperative transmission, of the terminals to perform the cooperative transmission and the modulation methods to be requested for the terminals to perform the cooperative transmission, respectively, for the cooperative transmission includes allocating each column of the STBC matrix to each of the terminals to perform the cooperative transmission, and the requesting of the terminals to perform the cooperative transmission, to perform the data modulation according to the identified modulation methods, respectively, includes transmitting, to a base station, column allocation information indicating execution of the data modulation according to modulation methods that are indicated by the columns allocated to the terminals to perform the cooperative transmission, respectively.

In accordance with another aspect of the disclosure, the information about the terminals to perform the cooperative transmission includes information about terminals selected based on the code matrix, and the selected terminals may be terminals included in a plurality of overlapping networks to perform the cooperative transmission.

In accordance with another aspect of the disclosure, the requesting of the generation of the communication group includes obtaining a policy control function (PCF) identification (ID) of a PCF for a terminal connected to another network, transmitting, to the terminal, participation request information for the communication group by using the PCF ID, and generating the communication group with the terminal, based on a response to the participation request information.

In accordance with another aspect of the disclosure, the transmitting, to the terminal, of participation request information for the communication group by using the PCF ID includes instantiating, as a Home-PCF, the PCF for the terminal connected to the other network, by using the PCF ID, instantiating, as a Visited-PCF, a PCF included in a network including the AMF, and transmitting, to the Visited-PCF, participation request information for the communication group, and the participation request information for the communication group is transmitted from the Visited-PCF to the Home-PCF, and then transmitted to the terminal.

In accordance with another aspect of the disclosure, the requesting of the generation of the communication group includes transmitting a logical attachment request to at least one terminal, which is connected to another network and has accepted a request to participate in the communication group, and requesting handover from the at least one terminal, based on a response to the logical attachment request.

In accordance with another aspect of the disclosure, a base station included in a network including the AMF may be physically attached to at least one terminal, which is connected to another network and has accepted a request to participate in the communication group.

In accordance with another aspect of the disclosure, the method of controlling communication of a plurality of devices belonging to a communication group further includes receiving, from another distributed artificial intelligence entity included in another network, information of the other distributed artificial intelligence entity including information about a code matrix performed by the other distributed artificial intelligence entity and information about terminals, transmitting the information of the other distributed artificial intelligence entity to the distributed artificial intelligence entity included in the network including the AMF, based on the information of the other distributed artificial intelligence entity, receiving, from the distributed artificial intelligence entity, information for instructing to change a size of a code matrix, and based on the information for instructing to change the size of the code matrix, transmitting, to a base station, the information for instructing to change the size of the code matrix.

In accordance with another aspect of the disclosure, the method of controlling communication of a plurality of devices belonging to a communication group further includes transmitting, to a base station, a scheduling request for the cooperative transmission for the terminals to perform the cooperative transmission, the transmitting of the scheduling request to the base station includes transmitting the scheduling request to a mobility management entity (MME), and the scheduling request may be transmitted from the MME to a proximity services function (PSF), and then transmitted from the PSF to the base station.

In accordance with another aspect of the disclosure, an AMF for controlling communication of a plurality of terminals belonging to a communication group is provided. The AMF includes a communication unit, and at least one processor coupled to the communication unit, and the at least one processor may be configured to request generation of the communication group, control the communication unit to receive, from a distributed artificial intelligence entity, information about terminals to perform cooperative transmission among the plurality of terminals included in the communication group, identify, based on the information about the terminals to perform the cooperative transmission, the terminals to perform the cooperative transmission and modulation methods to be requested for the terminals to perform the cooperative transmission, respectively, for the cooperative transmission, and request the terminals to perform the cooperative transmission, to perform data modulation according to the modulation methods, respectively.

In accordance with another aspect of the disclosure, the at least one processor may be further configured to invoke the distributed artificial intelligence entity, and control the communication unit to request, from the distributed artificial intelligence entity, information about a code matrix to be used for the cooperative transmission, and receive, from the distributed artificial intelligence entity, the information about the code matrix indicating the number of terminals to perform the cooperative transmission.

In accordance with another aspect of the disclosure, the at least one processor may be further configured to obtain a PCF ID of a PCF for a terminal connected to another network, control the communication unit to transmit, to the terminal, participation request information for the communication group by using the PCF ID, and generate the communication group with the terminal, based on a response to the participation request information.

In accordance with another aspect of the disclosure, the at least one processor may be further configured to control the communication unit to transmit a logical attachment request to at least one terminal, which is connected to another network and has accepted a request to participate in the communication group, and request handover from the at least one terminal, based on a response to the logical attachment request, and a base station included in a network including the AMF is physically attached to at least one terminal, which is connected to another network and has accepted a request to participate in the communication group.

In accordance with another aspect of the disclosure, the at least one processor may be further configured to control the communication unit to receive, from another distributed artificial intelligence entity included in another network, information of the other distributed artificial intelligence entity including information about a code matrix performed by the other distributed artificial intelligence entity and information about terminals, control the communication unit to transmit the information of the other distributed artificial intelligence entity to the distributed artificial intelligence entity included in the network including the AMF, control the communication unit to, based on the information of the other distributed artificial intelligence entity, receive, from the distributed artificial intelligence entity, information for instructing to change a size of a code matrix, and control the communication unit to, based on the information for instructing to change the size of the code matrix, transmit, to a base station, the information for instructing to change the size of the code matrix.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a communication group formed in overlapping networks of a wireless communication system, according to an embodiment of the disclosure;

FIG. 2 is a diagram illustrating signal and data flows for forming a communication group, according to an embodiment of the disclosure;

FIG. 3 is a diagram illustrating signal and data flows for forming a communication group, according to an embodiment of the disclosure;

FIG. 4 is a diagram illustrating signal and data flows between overlapping networks that form a communication group, according to an embodiment of the disclosure;

FIG. 5 is a diagram illustrating a network structure in a state in which a communication group that is to perform cooperative transmission is established, according to an embodiment of the disclosure;

FIG. 6 is a diagram illustrating a network structure in a state in which a communication group that is to perform cooperative transmission is established, according to an embodiment of the disclosure;

FIG. 7 is a flowchart of a method, performed by an access and mobility management function (AMF), of controlling communication of a plurality of devices belonging to a communication group in a wireless communication system, according to an embodiment of the disclosure;

FIG. 8 is a flowchart illustrating data transmission and reception for forming a communication group, according to an embodiment of the disclosure;

FIG. 9 is a flowchart illustrating data transmission and reception for forming a communication group, according to an embodiment of the disclosure;

FIG. 10 is a flowchart illustrating data transmission and reception for terminals included in a communication group that is to perform cooperative transmission, according to an embodiment of the disclosure;

FIG. 11 is a flowchart illustrating data transmission and reception for changing a code matrix used for cooperative transmission, according to an embodiment of the disclosure;

FIG. 12 is a flowchart illustrating data transmission and reception for terminals included in a communication group that is to perform cooperative transmission, in a case in which a code matrix is expanded, according to an embodiment of the disclosure;

FIG. 13 is a flowchart illustrating data transmission and reception for requesting scheduling for terminals included in a communication group that is to perform cooperative transmission, according to an embodiment of the disclosure;

FIG. 14 is a block diagram of an AMF according to an embodiment of the disclosure; and

FIG. 15 is a block diagram of a distributed artificial intelligence entity according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In addition, terms, such as ‘first’ or ‘second’ may be used to describe various elements, but the elements should not be limited by the terms. These terms are only used to distinguish one element from another element.

In addition, terms used herein are for describing particular embodiments and are not intended to limit the scope of the disclosure. In addition, throughout the disclosure, when a part is referred to as being “connected to” another part, it may be “directly connected to” the other part or be “electrically connected to” the other part through an intervening element. In addition, when an element is referred to as “including” a component, the element may additionally include other components rather than excluding other components as long as there is no particular opposing recitation.

In addition, when there is no description explicitly specifying an order of operations of a method according to the disclosure, the operations may be performed in an appropriate order. The disclosure is not limited to the order of the operations described.

As used herein, phrases, such as “in an embodiment” does not necessarily indicate the same embodiment.

An embodiment of the disclosure may be represented by block components and various process operations. Some or all of the functional blocks may be implemented by any number of hardware and/or software elements that perform particular functions. For example, the functional blocks of the disclosure may be embodied by at least one microprocessor or by circuit components for a certain function. In addition, for example, the functional blocks of the disclosure may be implemented using various programming or scripting languages. The functional blocks may be implemented by using various algorithms executable by one or more processors. Furthermore, the disclosure may employ known technologies for electronic settings, signal processing, and/or data processing.

In addition, connection lines or connection members between components illustrated in the drawings are merely of functional connections and/or physical or circuit connections. Various alternative or additional functional connections, physical connections or circuit connections may be present in a practical device.

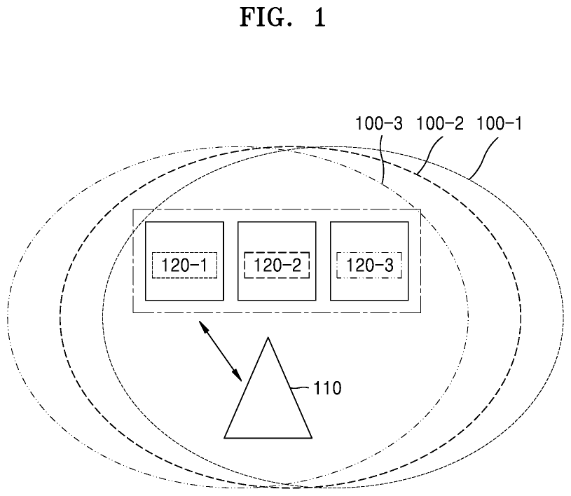

FIG. 1 is a diagram illustrating a communication group formed in overlapping networks of a wireless communication system, according to an embodiment of the disclosure.

Referring to FIG. 1, networks 100-1, 100-2, and 100-3 may be overlapping networks. In the disclosure, that networks overlap each other may mean that there are several networks in one area and the networks are operated by different network operators. For example, the overlapping networks 100-1, 100-2, and 100-3 may refer to networks operated by different network operators, respectively, and are in the same area. An overlapping network environment may allow physical connection to a serving radio access network (RAN) such that cooperative coding may be used in a physical layer. Cooperative coding of a plurality of terminals may be performed in a physical layer (PHY) of an open systems interconnection (OSI) model, by physical overlap between relevant networks.

A base station 110 is a network infrastructure that provides terminals 120-1, 120-2, and 120-3 with wireless access. The base station 110 has a coverage defined as a certain geographic area based on the distance over which signals may be transmitted. The base station 110 may be referred to as an access point (AP), an evolved NodeB (eNodeB, eNB), a 5th generation (5G) node, a next-generation NodeB (gNB), a wireless point, a transmission/reception point (TRP), or other terms having equivalent technical meanings.

The base station 110 according to an embodiment of the disclosure may be a gNB of 5G. However, some eNB functions of 4th Generation (4G) may be retained in the base station 110 due to proximity services (ProSe) functions.

In the disclosure, each of the terminals 120-1, 120-2, and 120-3 refers to a terminal included in each overlapping network. For example, the terminal 120-1 may refer to a terminal receiving a service from the overlapping network 100-1, the terminal 120-2 may refer to a terminal receiving a service from the overlapping network 100-2, and the terminal 120-3 may refer to a terminal receiving a service from the overlapping network 100-3.

Each of the terminals 120-1, 120-2, and 120-3 may refer to a device used by a user. The terminals 120-1, 120-2, and 120-3 according to embodiments of the disclosure may include a stationary terminal or a mobile terminal implemented as a computer device, and may communicate with other terminals and/or servers by using a wireless or wired communication method. For example, the terminals may include, but are not limited to, a smart phone, a mobile terminal, a laptop computer, a digital broadcasting terminal, a personal digital assistant (PDA), a portable multimedia player (PMP), a navigation system, and a slate personal computer (PC), a tablet PC, a digital television (TV), a desktop computer, a refrigerator, a projector, a car, a smart car, a printer, and the like.

In the disclosure, the terminals 120-1, 120-2, and 120-3 may refer to terminals included in a communication group to perform cooperative transmission according to an embodiment.

In the disclosure, the communication group is a group consisting of terminals receiving services from different networks. The terminals participating in the communication group according to the disclosure may transmit data in cooperation with each other.

In the disclosure, the cooperative transmission may refer to a method in which a plurality of terminals belonging to a communication group transmit data by performing modulation on the same data by using different modulation methods. For example, the cooperative transmission may mean that a plurality of terminals belonging to a communication group in an overlapping network perform physical layer (PHY) coding in cooperation with each other. As an example according to the disclosure, in order for terminals belonging to a communication group to perform cooperative transmission, each terminal may perform modulation based on information about a column of a space-time block coding (STBC) matrix allocated to the terminal.

The terminals 120-1, 120-2, and 120-3 may communicate with the base station 110 through a radio channel. A link from the base station 110 to the terminal 120-1, the terminal 120-2, or the terminal 120-3 may be referred to as downlink (DL), and a link from the terminal 120-1, the terminal 120-2, or terminal 120-3 to the base station 110 may be referred to as an uplink (UL). At least one of the terminal 120-1, the terminal 120-2, or the terminal 120-3 may be a device for performing machine-type communication (MTC), and may not be carried by a user. Each of the terminal 120 and the terminal 130 may be referred to as, in addition to ‘terminal’, ‘user equipment (UE)’, ‘mobile station (MS)’, ‘subscriber station’, ‘remote terminal’, ‘wireless terminal’, ‘user device’, or other terms having equivalent technical meanings.

The base station 110, the terminal 120-1, the terminal 120-2, or the terminal 120-3 may transmit and receive radio signals in a millimeter-wave (mmWave) band (e.g., 28 GHz, 30 GHz, 38 GHz, or 60 GHz). In this case, in order to improve a channel gain, the base station 110, the terminal 120, and the terminal 130 may perform beamforming.

In the disclosure, space-time coding may refer to a multi-antenna transmission method for mapping modulation symbols to time and space domains (transmit antennas) in order to obtain diversity by multiple transmit antennas.

According to an embodiment of the disclosure, a method and apparatus of the disclosure may operate in emergency systems that operate in a disaster situation. As a non-limiting example, the emergency system may include a public safety Long-Term Evolution (PS-LTE) system.

In an emergency system according to an embodiment of the disclosure, relevant people may be instantly connected to a group with the help of an Internet protocol (IP) multimedia subsystem (IMS). For example, immediate group connection may be similar to Terrestrial Trunked Radio (TETRA).

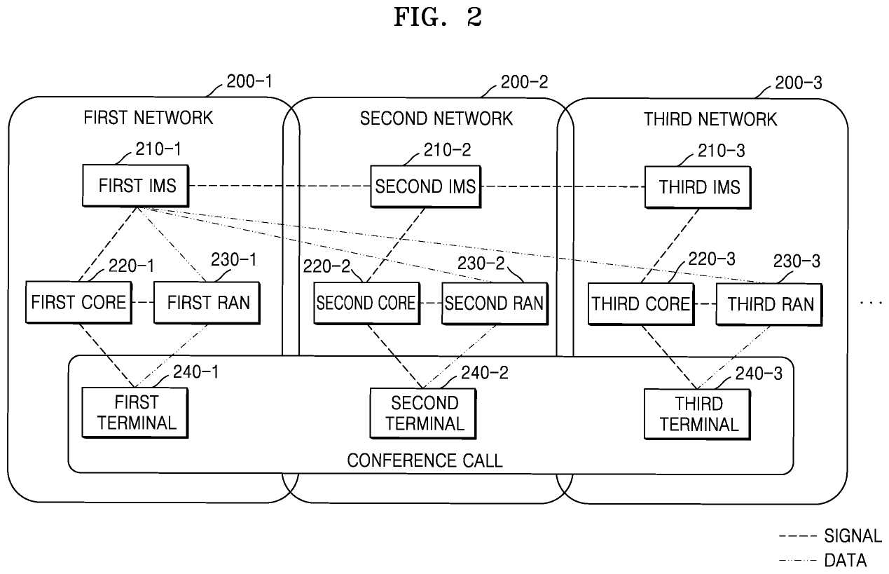

FIG. 2 is a diagram illustrating signal and data flows for forming a communication group, according to an embodiment of the disclosure.

Referring to FIG. 2, it illustrates an initial interconnection state of terminals. The initial interconnection state may refer to a state in which all terminals may be identified. Here, the interconnection according to the disclosure may encompass all interconnections guaranteeing the possibility that terminals may be identified. For explanation, in the disclosure, it is assumed that interconnection is achieved through a conference call, but the interconnection state is not limited to a conference call. A call according to the disclosure may be replaced with another form of communication that allows terminals to be included in a communication group to perform cooperative transmission.

Each of a first network 200-1, a second network 200-2, and a third network 200-3 may refer to an overlapping network. For example, the first network 200-1, the second network 200-2, and the third network 200-3 may refer to networks that overlap one another in a particular territory, and are operated by different network operators.

The first network 200-1, the second network 200-2, and the third network 200-3 according to an embodiment of the disclosure may be classified according to the operators that operate the networks, and may include different core networks and RANs, respectively. The number of other overlapping networks of the disclosure is not limited, and although FIG. 2 illustrates a state in which three networks overlap one another, but the disclosure is not limited thereto.

A core according to the disclosure may refer to a core network. According to an embodiment of the disclosure, the first network 200-1 may include a first core 220-1 and a first RAN 230-1, the second network 200-2 may include a second core 220-2 and a second RAN 230-2, and the third network 200-3 may include a third core 220-3 and a third RAN 230-3.

According to an embodiment of the disclosure, the first network 200-1 may include a first IMS 210-1, the second network 200-2 may include a second IMS 210-2, and the third network 200-3 may include a third IMS 210-3.

A first terminal 240-1, a second terminal 240-2, and a third terminal 240-3 may refer to terminals connected to the first network 200-1, the second network 200-2, and the third network 200-3, which are different networks, respectively. The first terminal 240-1, the second terminal 240-2, and the third terminal 240-3 belonging to different networks may form or configure a communication group to perform cooperative transmission, and may perform the cooperative transmission within the communication group.

The first terminal 240-1 according to an embodiment of the disclosure may refer to a terminal included in a network that initiates the communication group, and the second terminal 240-2 and the third terminal 240-3 may refer to participant terminals of the communication group in a conference call through an IMS.

The first terminal 240-1 according to an embodiment of the disclosure may be connected to the first RAN 230-1 and the first core 220-1 of the first network 200-1. In addition, the first core 220-1 and the first RAN 230-1 may be connected to the first IMS 210-1. The first RAN 230-1 according to an embodiment may include a first base station (not shown).

The second terminal 240-2 may be connected to the second RAN 230-2 and the second core 220-2 of the second network 200-2. In addition, the second core 220-2 and the second RAN 230-2 may be connected to the second IMS 210-2. The second RAN 230-2 may include a second base station (not shown).

The third terminal 240-3 may be connected to the third RAN 230-3 and the third core 220-3 of the third network 200-3. In addition, the third core 220-3 and the third RAN 230-3 may be connected to the third IMS 210-3. The third RAN 230-3 may include a third base station (not shown).

The first terminal 240-1 may be a caller or an originator. The second terminal 240-2 and the third terminal 240-3 may be terminals participating in the conference call. In order to perform the conference call, the second RAN 230-2 of the second terminal 240-2 and the third RAN 230-3 of the third terminal 240-3, which are the participants, may be connected to the first IMS 210-1 of the first terminal 240-1, which is the caller.

FIG. 2 illustrates signaling flows and data flows between the terminals, the cores, the RANs, and the IMSs. For example, the signaling flow may refer to a flow in which a control signal is transmitted.

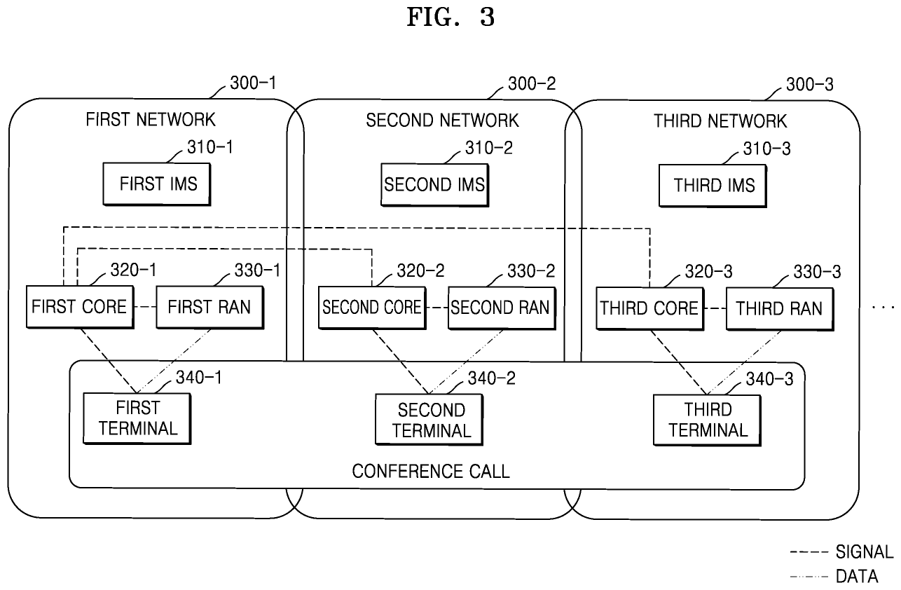

FIG. 3 is a diagram illustrating signal and data flows for forming a communication group, according to an embodiment of the disclosure.

Referring to FIG. 3, it is a diagram illustrating a preparation stage for reattaching terminals (e.g., a second terminal 340-2 and a third terminal 340-3) to a first RAN 330-1, a second RAN 330-2, a third RAN 330-3, and flows of signals and data occurring in the preparation stage. Architecture components of a first core 320-1, a second core 320-2, a third core 320-3 in a case in which a communication group is formed may be described with reference to FIG. 3. Here, a first network 300-1, a second network 300-2, a third network 300-3 may refer to an originating network, and the first core 320-1, a second core 320-2, a third core 320-3, respectively, may refer to an originating core. According to an embodiment of the disclosure, the first network 300-1 may include a first IMS 310-1, the second network 300-2 may include a second IMS 310-2, and the third network 300-3 may include a third IMS 310-3. Here, initiation of cooperative communication may occur in the originating network.

An access and mobility management function (AMF) (not shown) included in the first core 320-1 of the first network 300-1 according to an embodiment of the disclosure may initiate an overall procedure according to an embodiment of the disclosure. A distributed artificial intelligence (DAI) entity (not shown) may refer to a main orchestrator.

The AMF included in the first core 320-1 may request formation of a communication group to perform cooperative transmission. A first terminal 340-1, the second terminal 340-2, and the third terminal 340-3 may be terminals participating in the communication group. The first terminal 340-1, the second terminal 340-2, and the third terminal 340-3 connected to different networks may be included in the communication group.

When the communication group according to an embodiment of the disclosure is formed, communication between cores may be performed, and in particular, communication between AMFs through policy control functions (PCFs) may be performed.

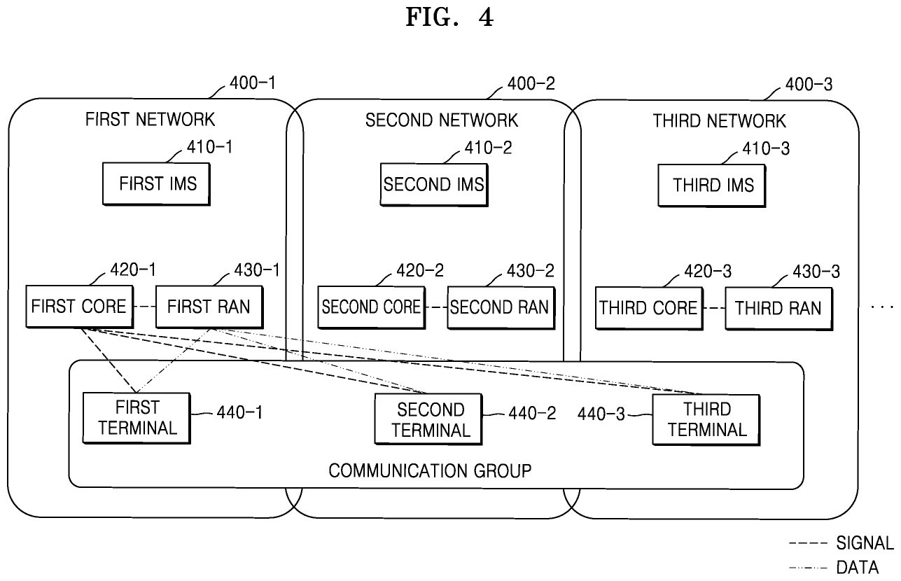

FIG. 4 is a diagram illustrating signal and data flows between overlapping networks that form a communication group, according to an embodiment of the disclosure.

FIG. 4 illustrates a state in which each terminal is reattached to the same RAN to perform cooperative transmission. In addition, FIG. 4 illustrates the flows of signals and data occurring in a state in which each terminal is reattached to the same RAN.

Referring to FIG. 4, it is a diagram illustrating a preparation stage for reattaching terminals (e.g., a second terminal 440-2 and a third terminal 440-3) to a first RAN 430-1, a second RAN 430-2, a third RAN 430-3, and flows of signals and data occurring in the preparation stage. Architecture components of a first core 420-1, a second core 420-2, a third core 420-3 in a case in which a communication group is formed may be described with reference to FIG. 4. Here, a first network 400-1, a second network 400-2, a third network 400-3 may refer to an originating network, and the first core 420-1, a second core 420-2, a third core 420-3, respectively, may refer to an originating core. According to an embodiment of the disclosure, the first network 400-1 may include a first IMS 410-1, the second network 400-2 may include a second IMS 410-2, and the third network 400-3 may include a third IMS 410-3. Here, initiation of cooperative communication may occur in the originating network.

Referring to FIG. 4, in a case in which all terminals belonging to various overlapping networks (e.g., a first terminal 440-1, a second terminal 440-2, and a third terminal 440-3) are physically reattached to a first RAN 430-1 and are logically reattached to a first core 420-1 of an originating network, cooperative transmission of the terminals belonging to the communication group may be performed. In order to configure the communication group, all terminals in the communication group need to operate as if they are physically connected to the same RAN. Accordingly, the second terminal 440-2 may be physically connected to the first RAN 430-1, and the third terminal 440-3 may be physically connected to the first RAN 430-1.

A conference call through an IMS according to an embodiment of the disclosure may be continuously performed through RANs (i.e., the second RAN and the third RAN) of the respective terminals, which are original points. Alternatively, in order to maintain the conference call through the IMS, the conference call may be served to the terminals, by the first RAN 430-1. However, the disclosure is not limited to the above-described embodiments of the disclosure, and instantiation of cooperative transmission, which is an embodiment of the disclosure, may be irrelevant to whether the conference call is maintained.

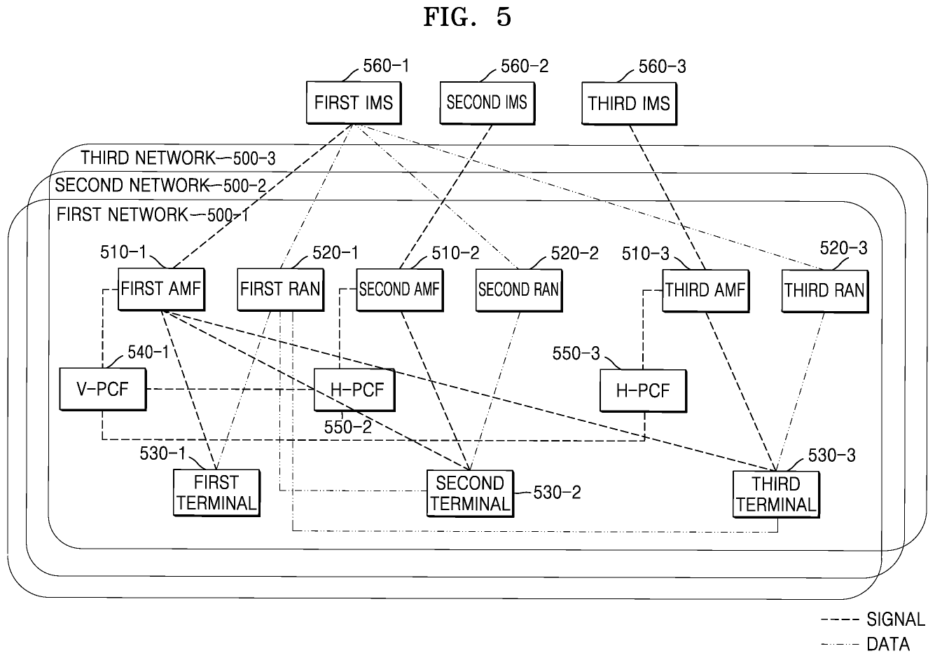

FIG. 5 is a diagram illustrating a network structure in a state in which a communication group that is to perform cooperative transmission is established, according to an embodiment of the disclosure.

Referring to FIG. 5, it includes a first IMS 560-1, a second 560-2, a third 560-3, a V-PCF 540-1, H PCF 550-2, and an H PCF 550-3 and connection between a first terminal 530-1, a second terminal 530-2, a third terminal 530-3, which are a plurality of terminals included in the communication group when the communication group is formed, and entities, and flows of signals and data may be described.

When the communication group is formed, the second terminal 530-2 and the third terminal 530-3 may be logically connected to or attached to a first AMF 510-1. The first terminal 530-1, the second terminal 530-2, and the third terminal 530-3 included in the communication group may transmit and receive signals to and from the first AMF 510-1. The signals according to an embodiment may include a control signal. The first terminal 530-1, the second terminal 530-2, and the third terminal 530-3 included in the communication group may transmit and receive data to and from a first RAN 520-1.

When the communication group is formed, a policy control function (PCF) included in a first network 500-1 may serve as a visited PCF (V-PCF), and a PCF included in a second network 500-2 and a PCF included in a third network 500-3 may serve as a home PCF (H-PCF). According to 3rd Generation Partnership Project (3GPP) approaches, from the point of view of a terminal, a PCF of a network visited by the terminal may refer to a V-PCF, and the PCF of the network to which the terminal was originally connected (i.e., a home network) may refer to an H-PCF.

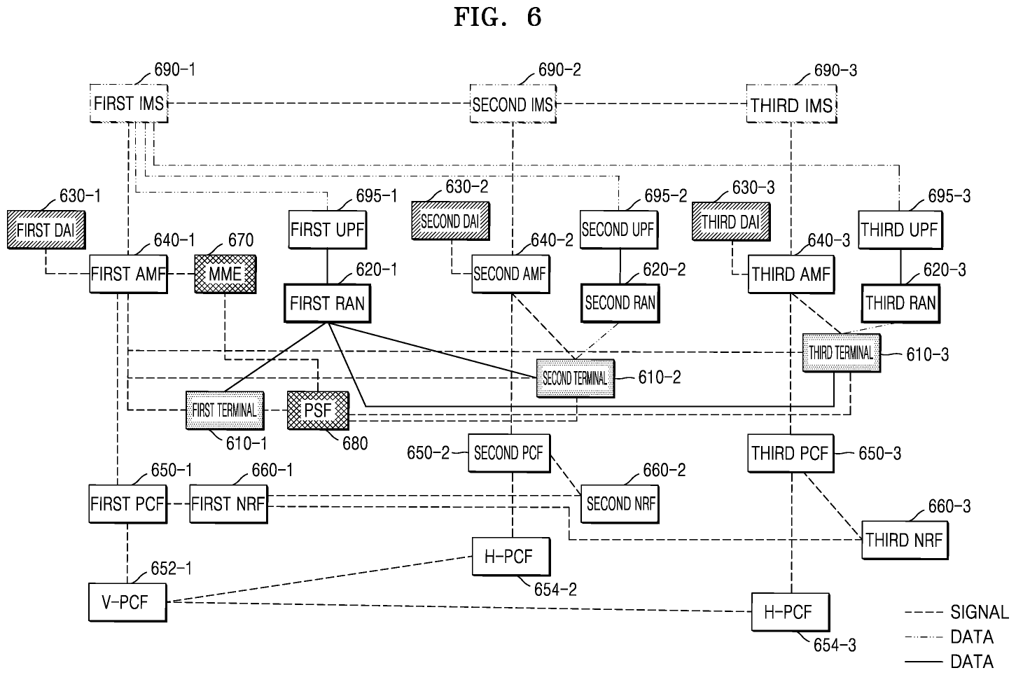

FIG. 5 is a diagram schematically illustrating a structure of a network according to the disclosure, and FIG. 6 illustrates a structure of a network according to the disclosure.

FIG. 6 is a diagram illustrating a network structure in a state in which a communication group that is to perform cooperative transmission is established, according to an embodiment of the disclosure.

Referring to FIG. 6, a first AMF 640-1, a first network repository function (NRF) 660-1, a first RAN 620-1, a first PCF 650-1, a first user plane function (UPF) 695-1, and the like may refer to entities included in a first core of a first network. In addition, the first core may further include a first mobility management entity (MME) 670-1 and a first proximity services function (PSF) 680-1.

For example, the first network may refer to a network to which a first terminal 610-1, which is the originating device, is connected. Alternatively, the first network may refer to an originating network, that is, a network including the first AMF 640-1 controlling cooperative communication according to the disclosure. The first terminal 610-1 may be logically connected to the first AMF 640-1 and physically connected to the first RAN 620-1.

A second AMF 640-2, a second NRF 660-2, a second RAN 620-2, a second PCF 650-2, and a second UPF 695-2 may refer to entities included in a second core of a second network.

For example, the second network may refer to a network to which a second terminal, which is a participant device participating in a conference call, is connected. Alternatively, the second network may refer to a network other than the originating network, and may refer to a network overlapping the first network, which is the originating network.

A third AMF 640-3, a third NRF 660-3, a third RAN 620-3, a third PCF 650-3, and a third UPF 695-3 may refer to entities included in a third core of a third network.

The third network may refer to a network to which a third terminal 610-3, which is a participant device participating in the conference call, is connected. Alternatively, the third network may refer to a network other than the originating network, and may refer to a network overlapping the first network, which is the originating network.

Although the first AMF is described as the AMF included in the originating network for convenience of description, the AMFs (e.g., the second AMF or the third AMF) included in the respective networks may serve as an originating AMF for controlling the cooperative communication of the terminals included in the communication group.

The first terminal 610-1, a second terminal 610-2, and the third terminal 610-3 may refer to terminals connected to different networks, such as the first network, the second network, and the third network, respectively. For example, the first terminal 610-1, the second terminal 610-2, and the third terminal 610-3 belonging to different networks may perform a conference call through an IMS. The first network, the second network, and the third network may refer to overlapping networks. Three overlapping networks are illustrated for convenience of description, but the disclosure is not limited thereto.

A first IMS 690-1 may inform of an invocation from the first terminal 610-1 to the first AMF 640-1. In addition, the first IMS 690-1 may inform of invocations of the first UPF 695-1, the second UPF 695-2, and the third UPF 695-3. The conference call through the IMS may be performed according to known methods. The conference call according to an embodiment may be switched to cooperative transmission.

The first AMF (e.g., the originating AMF) 640-1 according to an embodiment of the disclosure may perform asynchronous or synchronization initiation of communication groups to perform cooperative transmission. The asynchronous or synchronous initiation may mean that different networks may form a communication group to perform cooperative transmission by themselves or by using communication between DAI modules.

A core according to an embodiment may include a plurality of AMFs, but for convenience of description, it may be assumed that each network includes one AMF.

The first AMF 640-1 according to an embodiment of the disclosure may invoke a first DAI entity 630-1. The DAI in the disclosure may refer to a module used to perform cooperative transmission and cooperative coding. The DAI according to an embodiment may be instantiated, and may be invoked to operate only when the network performs operations defined in the disclosure. The DAI according to an embodiment of the disclosure may be implemented as an independent entity. In addition, according to another embodiment of the disclosure, the DAI may be a component of an AMF.

A function performed by the DAI entity according to an embodiment of the disclosure may be invoked by each AMF orchestrating functionality proposed in the disclosure. By the distribution characteristics of DAI, a plurality of cooperative transmissions coordinated by each of the overlapping networks may be coordinated, and communication between different DAI entities may be performed.

The first AMF 640-1 according to an embodiment of the disclosure may obtain, through NRF-to-NRF communication, PCF identifiers (IDs) (i.e., PCF identification information) regarding the second terminal 610-2 and the third terminal 610-3, which are remote terminals.

The first AMF 640-1 according to an embodiment of the disclosure may instantiate a V-PCF 652-1 and one or more H-PCFs 654-2 and 654-3. For example, in a case in which the first network is the originating network, the first PCF belonging to the first network may refer to a V-PCF, and the second PCF and the third PCF may refer to H-PCFs. Alternatively, the first PCF may include a V-PCF, and the second PCF and the third PCF may include an H-PCF. Alternatively, that the first AMF 640-1 instantiates the V-PCF 652-1 and the one or more H-PCFs 654-2 and 654-3 may mean that the first PCF 650-1 belonging to the first network is instantiated as the V-PCF 652-1, or may mean that the second PCF 650-2 and the third PCF 650-3 included in networks other than the originating network are instantiated as the H-PCFs 654-2 and 654-3, respectively. The H-PCFs 654-2 and 654-3 may refer to all PCFs providing services to remote terminals (e.g., the second terminal 610-2 and the third terminal 610-3), and the PCFs may become H-PCFs when trying to roam onto another network.

The first AMF 640-1 according to an embodiment of the disclosure may instantiate connections with a second DAI entity 630-2 and a third DAI entity 630-3, which are DAI entities attached to the second AMF 640-2 and the third AMF 640-3, which are AMFs serving the second terminal 610-2 and the third terminal 610-3, which are remote terminals, respectively. As described above, a function performed by a DAI entity may be invoked by the orchestrating functionality of each AMF proposed in the disclosure.

The first AMF 640-1 according to an embodiment of the disclosure may confirm an intention of the second terminal 610-2 and the third terminal 610-3, which are remote terminals, to participate in the communication group. The intention of each terminal to participate in the communication group may be changed.

The first AMF 640-1 according to an embodiment of the disclosure has obtained the PCF IDs of the second terminal 610-2 and the third terminal 610-3, which are remote terminals, and thus may use a control channel related to the PCF IDs. The H-PCFs 654-2 and 654-3 may transmit, to the terminals, request information from the first AMF 640-1 for confirming an intention to participate in the communication group. In addition, the H-PCFs 654-2 and 654-3 may obtain, from the second terminal 610-2 and the third terminal 610-3, information related to participation or an intention to participate and a confirmation of the request, and transmit the obtained information to the first AMF 640-1.

The first AMF 640-1 according to an embodiment of the disclosure may connect the second terminal 610-2 and the third terminal 610-3, which are remote terminals, to the first AMF 640-1, to form logical cooperative communication groups.

The first AMF 640-1 according to an embodiment of the disclosure may connect the second terminal 610-2 and the third terminal 610-3, which are remote terminals, to the first RAN 620-1 to instantiate physical cooperative communication groups.

The logical cooperative communication group may mean that a communication group is formed at the core network level and control communication is enabled. In addition, the physical cooperative communication group may mean that a communication group is formed at the RAN level and data communication is enabled.

In addition, at this stage, physical connections established to the RANs may occur simultaneously in several networks, and may be coordinated by the DAI entities.

Through the above-described embodiments of the disclosure, the first AMF 640-1 may establish a communication group.

The first DAI entity 630-1 according to an embodiment of the disclosure may select a code matrix. The code matrix may include a space-time block code matrix (i.e., a code matrix Cx). However, selection of the space-time block code matrix may be performed in an initial round when forming the communication group, and does not need to be performed every time according to an embodiment.

Each code matrix according to an embodiment of the disclosure may include several columns to be allocated to indicate modulation methods for the respective terminals.

The first DAI entity 630-1 according to an embodiment of the disclosure may allocate each column of the code matrix to each terminal, based on radio channel parameters between terminals constituting the communication group and a terminal served by the communication group.

The first DAI entity 630-1 according to an embodiment of the disclosure may provide information about the most suitable terminal for each code matrix column (i.e., the terminal corresponding to each code matrix column). However, request for information about the most suitable terminal may be performed in the initial round when forming the communication group, and does not need to be performed every time according to an embodiment. As artificial intelligence learning of DAI continues, the performance to find a suitable terminal may be improved.

Information allocated to each code matrix column may be delivered to each terminal through a physical connection established with the first RAN 620-1 according to an embodiment of the disclosure. The allocated information may refer to information about a method, performed by each terminal, of performing signal modulation in order to meet requirements of a selected or given space-time code.

Based on an instruction from the first DAI entity 630-1 according to an embodiment of the disclosure, the size of the code matrix Cx may be expanded or reduced. Dynamic switching between different codes may be allowed by expansion or reduction of the size of the code matrix. For example, dynamic switching between G2, G3 and G4, which are matrices with different numbers of columns, may be allowed, or switching to non-orthogonal or quasi-orthogonal designs that tend to have larger matrices may also be allowed.

The cooperative transmission according to an embodiment of the disclosure may be integrated with device-to-device (D2D) through an MME and a PSF (Prose function) for appropriate UL and DL transmission. Therefore, the cooperative transmission may be linked with PS-LTE technology. Terminals constituting a communication group to perform cooperative transmission may be a kind of extension of gNB. Here, in a case in which the terminals constituting the communication group serve a particular remote terminal to which a gNB cannot generally transmit data, it is necessary to determine whether all of the terminals constituting the communication group transmit data in a DL rather than a UL. Similarly, in a case in which data is transmitted from the remote terminal to the gNB through the communication group, all terminals constituting the communication group need to perform data transmission in a UL rather than a DL.

The first AMF 640-1 according to an embodiment of the disclosure may automatically update the above-described operations according to an instruction from the first DAI entity 630-1. In addition, all AMFs included in each network may also automatically update the above-described operations.

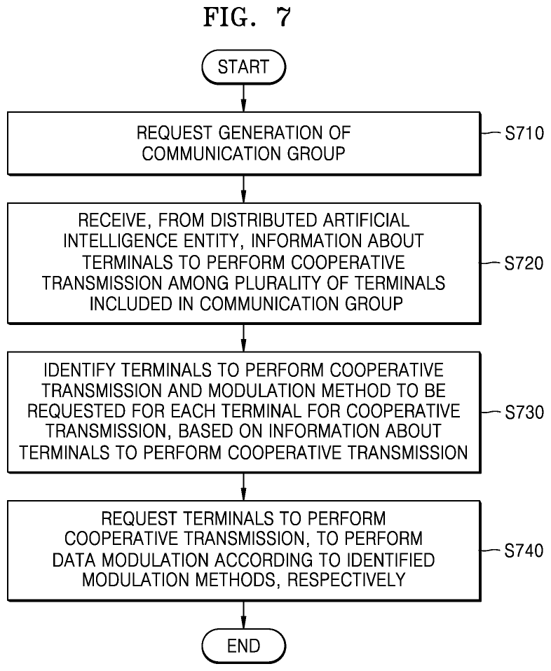

FIG. 7 is a flowchart of a method, performed by an AMF, of controlling communication of a plurality of devices belonging to a communication group in a wireless communication system, according to an embodiment of the disclosure.

Referring to FIG. 7, according to an embodiment of the disclosure, the AMF may refer to an AMF included in an originating network. For example, the AMF may refer to the first AMF 510-1 of FIG. 5 or the first AMF 640-1 of FIG. 6.

In operation S710, the AMF may request formation of a communication group.

The AMF according to an embodiment of the disclosure may obtain a PCF ID of a PCF for a terminal connected to another network. According to an embodiment of the disclosure, the AMF may obtain the PCF ID through NRF-to-NRF communication. The AMF may transmit participation request information for a communication group, to a terminal connected to the other network, by using the PCF ID. Based on a response to the participation request information, the AMF may form the communication group with the terminal included in the other network.

The AMF according to an embodiment of the disclosure may instantiate, as a H-PCF, a PCF for the terminal connected to the other network, by using the PCF ID. In addition, the AMF may instantiate, as a V-PCF, a PCF included in the same network as the AMF. The AMF may transmit, to the V-PCF, participation request information for the communication group.

The participation request information for the communication group according to an embodiment of the disclosure may be transmitted from the V-PCF to the H-PCF, and then transmitted to the terminal connected to the other network.

In addition, the AMF may transmit participation request information for a communication group to form a communication group with a terminal included in the network including the AMF. Based on a response to the participation request information, the AMF may form the communication group with the terminal included in the same network.

The AMF according to an embodiment of the disclosure may transmit a logical attachment request to at least one terminal, which is connected to the other network and has accepted a request to participate in the communication group. The AMF may request handover from the at least one terminal, based on a response to the logical attachment request.

A base station included in the same network as the AMF according to an embodiment of the disclosure may be physically attached to the at least one terminal, which is connected to the other network and has accepted the request to participate in the communication group.

In operation S720, the AMF may receive, from a DAI entity, information about terminals to perform cooperative transmission among a plurality of terminals included in the communication group.

The AMF according to an embodiment of the disclosure may invoke the DAI entity.

The information about the terminals to perform the cooperative transmission according to an embodiment of the disclosure may include information about terminals selected based on a code matrix. In addition, the selected terminals may be terminals included in a plurality of overlapping networks to perform cooperative transmission.

In operation S730, the AMF may identify the terminals to perform the cooperative transmission and a modulation method to be requested for each terminal for the cooperative transmission, based on the information about the terminals to perform the cooperative transmission.

The AMF according to an embodiment of the disclosure may request, from the DAI entity, information about a code matrix used for the cooperative transmission. The AMF may receive, from the DAI entity, the information about the code matrix indicating the number of terminals to perform the cooperative transmission.

The code matrix according to an embodiment of the disclosure may include an STBC matrix. In addition, the code matrix may include a quasi-orthogonal code matrix, a non-orthogonal code matrix, or space-time trellis coding (STTC) in which a flow graph is partially adjusted. For example, in a case in which an extra value is added, one or more columns may be allocated to one of the terminals in the communication group, based on quasi-orthogonal designs or non-orthogonal designs, which are larger code matrices.

The AMF according to an embodiment of the disclosure may allocate each column of the STBC matrix to each of the terminals to perform the cooperative transmission.

In operation S740, the AMF may request the terminals to perform the cooperative transmission to perform data modulation according to the identified modulation methods, respectively.

The AMF according to an embodiment of the disclosure may transmit, to the base station, column allocation information indicating execution of data modulation according to modulation methods respectively indicated by the columns allocated to the terminals to perform the cooperative transmission.

The AMF according to an embodiment of the disclosure may receive, from another DAI entity included in another network, information of the other DAI entity including information about a code matrix performed by the other DAI entity and information about terminals. The AMF may transmit the information of the other DAI entity to the DAI entity included in the same network as the AMF. Based on the information of the other DAI entity, the AMF may receive, from the DAI entity, information for instructing to change the size of the code matrix. In addition, the AMF may transmit, to the base station, the information for instructing to change the size of the code matrix, based on the information for instructing to change the size of the code matrix.

The AMF according to an embodiment of the disclosure may transmit, to the base station, a scheduling request for the cooperative transmission for the terminals to perform the cooperative transmission. When transmitting the scheduling request to the base station, the AMF may transmit the scheduling request to an MME. The scheduling request according to an embodiment may be transmitted from the MME to a PSF, and then transmitted from the PSF to the base station.

In order for the terminals belonging to the communication group according to an embodiment to perform the cooperative transmission, the terminals may perform modulation according to the columns of the STBC matrix that are allocated to the terminals, respectively. As a non-limiting example, the terminals may perform the modulation based on columns of a quasi-orthogonal or non-orthogonal matrix based on code matrices allocated to the respective terminals, STTC requiring partial adjustment in a flow graph, or the like.

Each column of a related-art STBC matrix corresponds to one terminal or each antenna included in a base station, but each column of the STBC matrix according to the disclosure may be allocated or correspond to each terminal included in the communication group. For communication of the terminals included in the communication group according to the disclosure, distribution of the columns of the code matrix to particular terminals is required, and the distribution needs to meet appropriate synchronization requirements.

Flows of messages between entities for controlling communication of a plurality of devices belonging to a communication group in a wireless communication system according to an embodiment of the disclosure will be described with reference to the following drawings. To describe the following drawings, the entities described above with reference to FIG. 6 may be used.

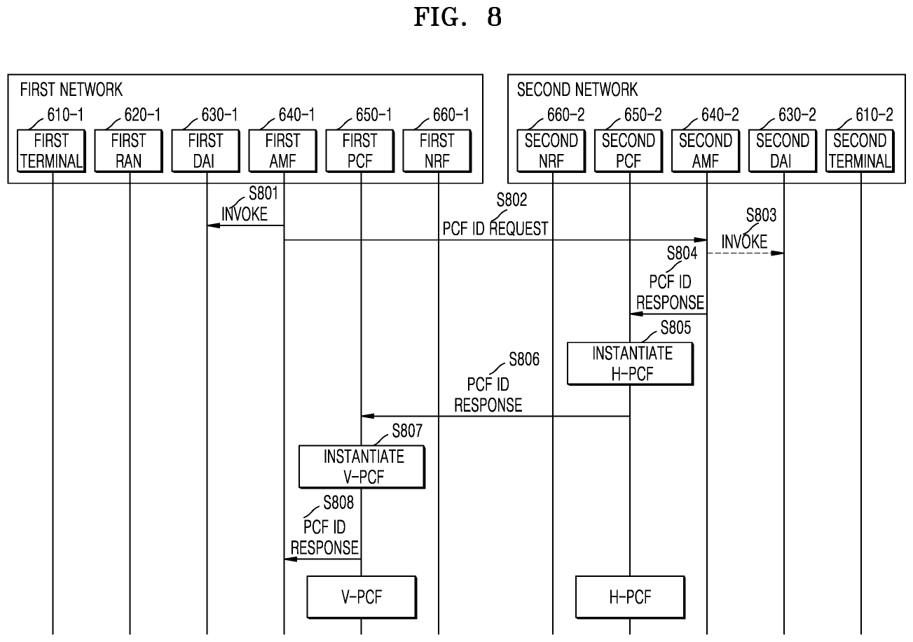

FIG. 8 is a flowchart illustrating data transmission and reception for forming a communication group, according to an embodiment of the disclosure.

Referring to FIG. 8, in operation S801, the first AMF 640-1 may invoke the first DAI entity 630-1 to perform a DAI function to help select terminals that need to perform spatio-temporal processing for cooperative communication.

The DAI entity according to an embodiment of the disclosure may select some terminals that are at better positions to participate in the cooperative transmission.

The spatio-temporal processing for cooperative communication according to an embodiment of the disclosure may refer to a technique using an orthogonal code (e.g., G2, G3, G4, H3, or H4), a non-orthogonal code, or a quasi-orthogonal code. In addition, as another example, the spatio-temporal processing may refer to application of trellis-based approaches. However, a spatio-temporal processing method refers to a method in which terminals may modulate data in cooperation with each other, and thus is not limited to the above-described examples.

In operation S802, the first AMF 640-1 may request a PCF ID (PCF ID request). The PCF ID may refer to an ID of a PCF for a terminal included in a network other than the network including the first AMF 640-1. Here, the first AMF 640-1 may transmit a PDF ID request to the first PCF 650-1, the first PCF 650-1 may transmit the PDF ID request to the first NRF 660-1, the first NRF 660-1 may transmit the PDF ID request to the second NRF 660-2, the second NRF 660-2 may transmit the PDF ID request to the second PCF 650-2, and the second PCF 650-2 may transmit the PDF ID request to the second AMF 640-2.

Reverse roaming within the same country may be performed through a request chain for obtaining the PCF ID of the terminal connected to another overlapping network, which is performed in operation S802. In addition, the terminal connected to the other network through the request chain may be physically connected to a RAN (i.e., the first RAN 620-1) of a serving network (i.e., the first network). According to the above method, a plurality of terminals may be attached to the first RAN 620-1 and a first core.

In operation S803, which is an optional operation, the second AMF 640-2 may selectively invoke the second DAI entity 630-2.

In operation S804, the second AMF 640-2 may respond with the PCF ID to the second PCF 650-2.

In operation S805, the second AMF 640-2 may instantiate an H-PCF (i.e., the second PCF 650-2) necessary for interaction in response to the PCF ID request from the first network.

In operation S806, the second PCF 650-2 may transmit a PCF ID response. For example, the second PCF 650-2 may transmit the PCF ID response to the second NRF 660-2, the second NRF 660-2 may transmit the PCF ID response to the first NRF 660-1, and the first NRF 660-1 may transmit the PCF ID response to the first PCF 650-1.

In operation S807, a V-PCF (i.e., the first PCF 650-1) may be instantiated on a requesting network side (i.e., the first network) through a response chain to the PCF ID request. The V-PCF according to an embodiment of the disclosure may also be instantiated in the requesting of the PCF ID.

In operation S808, the first PCF 650-1 may transmit the PCF ID to the first AMF 640-1. Here, a part of the first PCF 650-1 may be instantiated as a V-PCF.

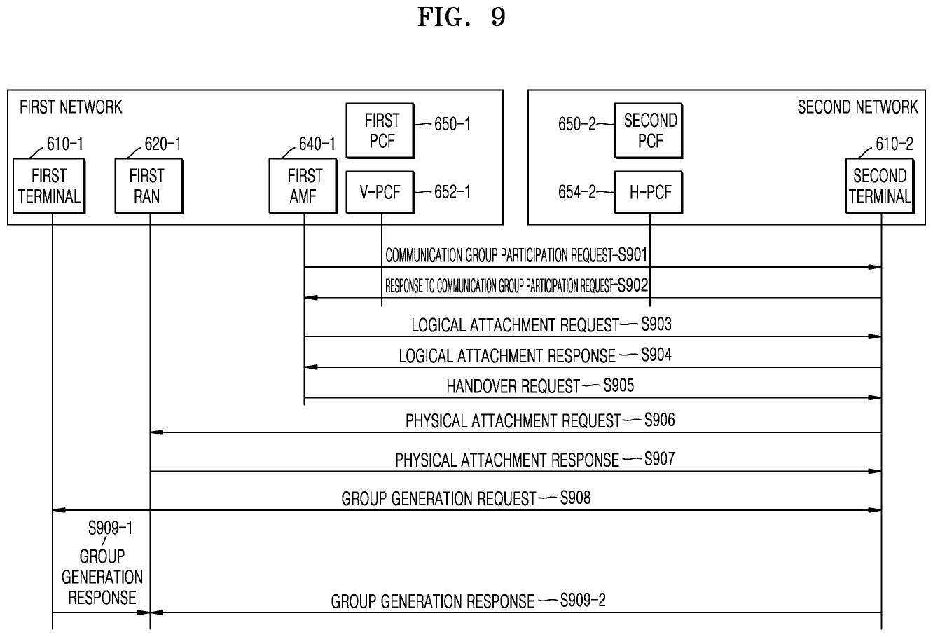

FIG. 9 is a flowchart illustrating data transmission and reception for forming a communication group, according to an embodiment of the disclosure.

Referring to FIG. 9, in operation S901, the first AMF 640-1 may transmit communication group participation request information to the V-PCF 652-1, the V-PCF 652-1 may transmit the communication group participation request information to the H-PCF 654-2, and the H-PCF 654-2 may transmit the communication group participation request information to the second terminal 610-2. The first AMF 640-1 may transmit the communication group participation request information to inquire whether a particular terminal (e.g., the second terminal 610-2) has an intention to participate in a communication group to perform cooperative transmission that may be restricted by a particular policy.

Referring to FIG. 8, because PCF IDs of terminals (e.g., the second terminal 610-2) included in the other network are obtained, a control channel using the PCF IDs may be used. Based on the communication group participation request information, the H-PCF 654-2 may obtain a confirmation by the second terminal 610-2 regarding whether to participate in the communication group, and information related to the second terminal 610-2 in participating in the communication group, and transmit them to the first AMF 640-1.

In operation S902, the second terminal 610-2, the H-PCF 654-2, and the V-PCF 652-1 may transmit a response of the second terminal regarding participation in the communication group, to the H-PCF 654-2, the V-PCF 652-1, and the first AMF 640-1, respectively. According to an embodiment of the disclosure, the response regarding participation in the communication group may include information indicating whether the second terminal has an intention to participate in the communication group to perform the cooperative transmission. In addition, the response regarding participation in the communication group may further include information related to the second terminal, and the like.

In operation S903, the first AMF 640-1 may transmit a logical attachment request to the second terminal 610-2. The logical attachment request according to an embodiment of the disclosure may refer to a request that an AMF and a terminal be logically connected to each other as if roaming in which signals are exchanged occurs. First, in a core network, logical attachment may be performed, and then a physical attachment between the RAN and the terminal may be performed. In operation S904, the second terminal 610-2 may transmit a logical attachment response to the first AMF 640-1. Here, the logical attachment response may refer to a response to the logical attachment request.

In operation S905, the first AMF 640-1 may transmit a handover request to the second terminal 610-2. The handover request may refer to requesting a physical handover to the RAN of the serving network. According to an embodiment of the disclosure, the first AMF 640-1 may request that the second terminal 610-2 be handed over to the first RAN 620-1.

In operation S906, the second terminal 610-2 may transmit a physical attachment request to the first RAN 620-1. The physical attachment request may refer to requesting that the second terminal 610-2 be attached to the serving RAN (i.e., the first RAN 620-1) through a handover (or virtual roaming). In operation S907, the first RAN 620-1 may transmit a physical attachment response to the second terminal 610-2. The physical attachment response may mean that the second terminal 610-2 may be granted a right to access the serving RAN (i.e., the first RAN 620-1).

In operation S908, the first RAN 620-1 may transmit a group formation request to the first terminal 610-1 and the second terminal 610-2. The group formation request according to an embodiment may refer to a request transmitted from the RAN to the terminals for forming a communication group.

In operations S909-1 and S909-2, the first RAN 620-1 may receive group formation responses from the first terminal 610-1 and the second terminal 610-2. The group formation response according to an embodiment may refer to a response regarding forming the communication group or subscribing the communication group that is transmitted by the terminals to the RAN.

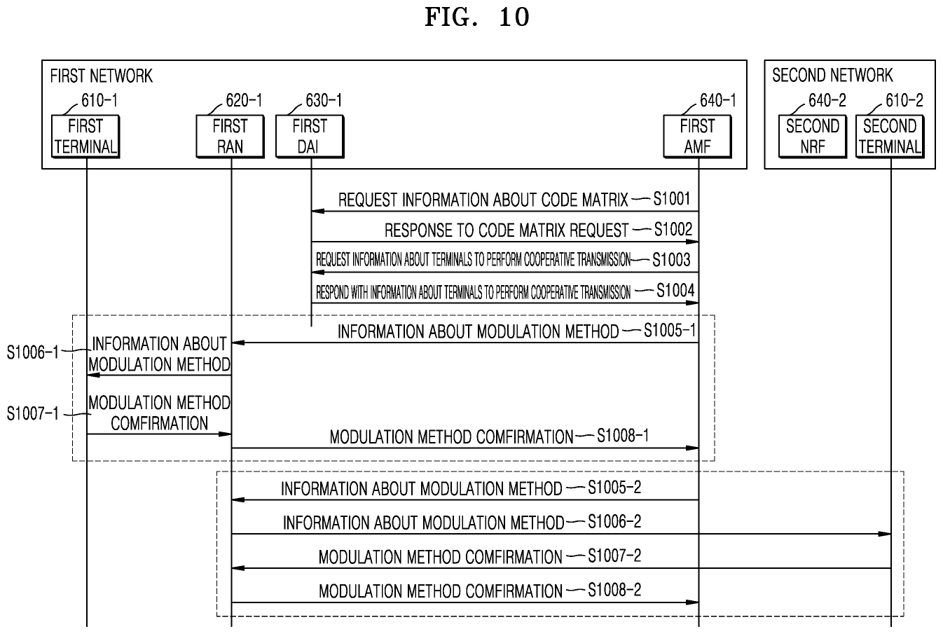

FIG. 10 is a flowchart illustrating data transmission and reception for terminals included in a communication group that is to perform cooperative transmission, according to an embodiment of the disclosure.

Referring to FIG. 10, in operation S1001, the first AMF 640-1 may request information about a code matrix from the first DAI entity 630-1. The requesting of the information about the code matrix may refer to requesting, from the DAI entity, information about an STBC matrix indicating the number of terminals to participate in cooperative transmission.

As described above, the STBC matrix according to an embodiment of the disclosure may refer to a technique using an orthogonal code (e.g., G2, G3, G4, H3, or H4). In addition, the code matrix according to another embodiment may refer to a different non-orthogonal code or quasi-orthogonal code. In addition, as another example, a trellis-based approach may be applied to the code matrix.

According to an embodiment of the disclosure, the size of the code matrix used for data transmission may be adjusted according to the number of terminals to participate in cooperative transmission. When the size of the code matrix cannot fit the number of terminals to participate in the cooperative transmission, separate groups may be configured by using other code matrices.

The terminals of the communication group according to an embodiment may perform transmission in cooperation with each other. A conference call is part of an initial stage and may be in progress at the time of the cooperative transmission, or may be suspended according to another embodiment. For example, the conference call may not be part of a cooperative transmission process.

In operation S1002, the first DAI entity 630-1 may transmit, to the first AMF 640-1, a response to the code matrix request. The response to the code matrix request according to an embodiment of the disclosure may include information about the code matrix selected by the first DAI entity, and may include information indicating the number of terminals to perform the cooperative transmission.

The first DAI entity 630-1 according to an embodiment of the disclosure may determine the optimal number of terminals to perform the cooperative transmission, and transmit, to the first AMF 640-1, the optimal number of terminals. The first DAI entity 630-1 may derive the information about the number of terminals, from response information to the communication group participation request described above with reference to FIG. 9.

The cooperative transmission according to an embodiment of the disclosure may include, but is not limited to, performing a conference call. In a case in which the conference call is performed, an additional signal may be added to switch the conference call to a single IMS (of the original network). Alternatively, in a case in which the conference call is performed, the fact that all terminals are still connected to the original RAN may be used to maintain the conference call.

In operation S1003, the first AMF 640-1 may request information about terminals to perform the cooperative transmission. Here, the information about the terminals to perform the cooperative transmission may refer to information about a terminal most suitable for performing the cooperative transmission.

In operation S1004, a response including terminal information for the cooperative transmission may be transmitted. Here, the response including the terminal information for the cooperative transmission may refer to a response of the DAI entity to terminal request information for the cooperative transmission.

The first DAI entity 630-1 according to an embodiment of the disclosure may select an optimal terminal for the cooperative transmission and provide information about the selected terminal. For example, the first DAI entity 630-1 may include information indicating that a second terminal and a third terminal are selected.

The first DAI entity 630-1 according to another embodiment may provide specification information of suitable terminals. For example, based on the specification information of the terminals provided by the first DAI entity 630-1, the first AMF 640-1 may determine a terminal for which the specification information is satisfied.

The first DAI entity 630-1 according to an embodiment of the disclosure may determine a modulation method to be performed by each terminal, based on radio channel parameters of the terminals. According to an embodiment of the disclosure, the modulation method to be performed by each terminal may be determined by assigning each column of a code matrix to each terminal.

The first DAI entity 630-1 according to an embodiment of the disclosure may allocate each column of the code matrix to each terminal, based on radio channel parameters between terminals constituting the communication group and a terminal served by the communication group.

The response to the code matrix request according to an embodiment of the disclosure may include information about the terminals selected for the cooperative transmission, a modulation method to be requested for each terminal for the cooperative transmission, information about the column of the code matrix allocated to each terminal for the cooperative transmission, or the like. Here, the information about the columns of the code matrix allocated to the respective terminals may refer to information indicating signal modulation methods that the respective terminals need to perform in order to meet requirements of selected or preset STBC.

In operations S1005-1 to S1008-1, the first AMF 640-1 may transmit, to the first terminal 610-1, information about a modulation method to be requested for the first terminal 610-1 for the cooperative transmission.

In operation S1005-1, the first AMF 640-1 may transmit, to the first RAN 620-1, the information about the modulation method to be requested for the first terminal 610-1 for the cooperative transmission. According to an embodiment of the disclosure, the information about the modulation method may refer to information requesting each terminal to perform baseband processing (modulation) according to a particular column of an STBC matrix preselected by the first DAI entity 630-1. Here, the information about the modulation method may include information about the column of the code matrix. In operation S1006-1, the first RAN 620-1 may transmit, to the first terminal 610-1, the information about the modulation method indicated for the first terminal 610-1. For example, in operation S1006-1, the first AMF 640-1 may request the first terminal 610-1 to perform baseband processing according to the first column of the STBC matrix.

In operation S1007-1, the first RAN 620-1 may receive, from the first terminal 610-1, a modulation method confirmation response. The modulation method confirmation response according to an embodiment may refer to a message including information indicating that the terminal has confirmed the modulation method indicated for the terminal. In addition, the modulation method confirmation response may refer to information indicating that each terminal has confirmed information about a column of the code matrix provided to the terminal. For example, modulation method confirmation responses are responses from the terminals selected by the first DAI entity 630-1, indicating that they have confirmed information about or values of columns allocated to the terminals, respectively. In operation S1008-1, the first RAN 620-1 may transmit, to the first AMF 640-1, the modulation method confirmation response.

In operations S1005-2 to S1008-2, the first AMF 640-1 may transmit, to the second terminal 610-2, information about a modulation method requested for the second terminal 610-2 for the cooperative transmission.

In operation S1005-2, the first AMF 640-1 may transmit, to the first RAN 620-1, the information about the modulation method requested for the second terminal 610-2 for the cooperative transmission. In operation S1006-2, the first RAN 620-1 may transmit, to the second terminal 610-2, the information about the modulation method indicated for the second terminal 610-2. For example, in operation S1006-2, the first AMF 640-1 may request the second terminal 610-2 to perform baseband processing according to the first column of the STBC matrix. In operation S1007-2, the first RAN 620-1 may receive, from the second terminal 610-2, a modulation method confirmation response. In operation S1008-2, the first RAN 620-1 may transmit, to the first AMF 640-1, the modulation method confirmation response.

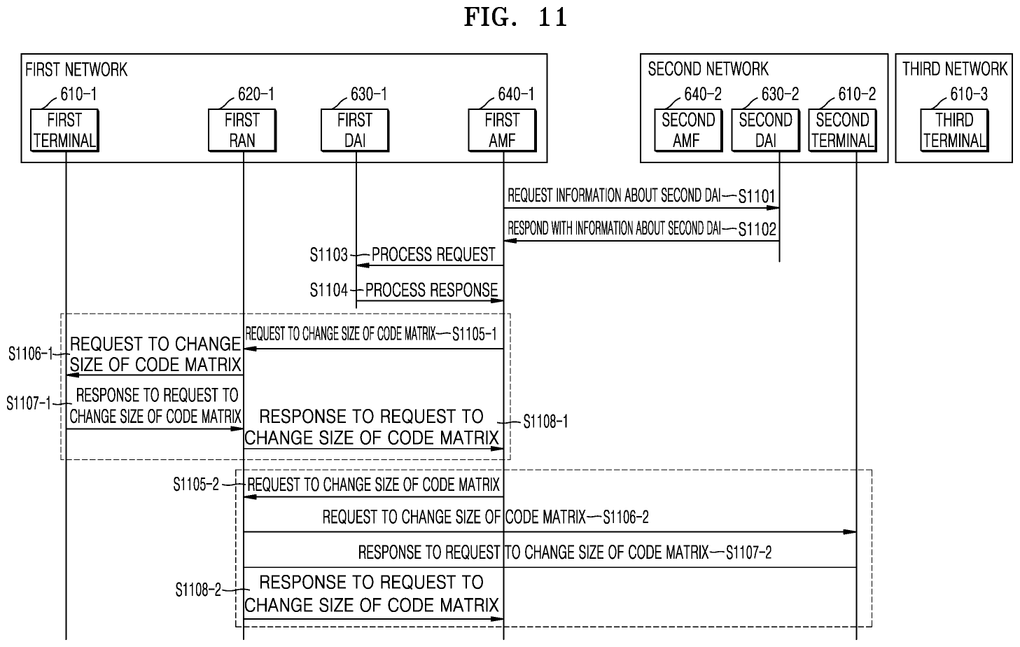

FIG. 11 is a flowchart illustrating data transmission and reception for changing a code matrix used for cooperative transmission, according to an embodiment of the disclosure.

Referring to FIG. 11, in operation S1101, the first AMF 640-1 may request, from the second DAI entity 630-2, information about the second DAI entity 630-2. In operation S1102, the first AMF 640-1 may receive, from the second DAI entity 630-2, the information about the second DAI entity 630-2.

The information about the second DAI entity 630-2 according to an embodiment of the disclosure may include information about terminals determined by the second DAI entity 630-2 to perform the cooperative transmission, a modulation method determined by the second DAI entity 630-2 to be requested for each terminal, information about a column of the code matrix allocated to each terminal by the second DAI entity 630-2, or the like.

According to an embodiment of the disclosure, the first AMF 640-1 may receive information from other DAI entities than the first DAI entity 630-1 belonging to the same network as the first AMF 640-1. Through the above-described operations, all distributed processes may efficiently operate in different networks.

In operation S1103, the first AMF 640-1 may transmit the information about the second DAI entity 630-2 to the first DAI entity 630-1, and request, from the first DAI entity 630-1, a process that may be performed based on the information. According to an embodiment of the disclosure, a process of changing the size of the code matrix may be performed based on the information about the second DAI entity 630-2. Thus, the first AMF 640-1 may transmit the information about the second DAI entity 630-2 to the first DAI entity 630-1, and request, from the first DAI entity 630-1, a confirmation of whether to change the size of the code matrix, based on the information.

In operation S1104, the first AMF 640-1 may receive, from the first DAI entity 630-1, a response to the process request. For example, the first DAI entity 630-1 may determine, based on the information about the second DAI entity 630-2, whether to change the size of the code matrix currently being used. Changing the size of the code matrix may refer to changing the number of terminals participating in the cooperative transmission.

In operations S1105-1 to S1108-1, the first AMF 640-1 may instruct the first terminal 610-1 to change the size of the code matrix being currently used.

In operation S1105-1, the first AMF 640-1 may transmit, to the first RAN 620-1, a request to change the size of the code matrix. The first DAI entity 630-1 according to an embodiment of the disclosure may provide the first AMF 640-1 with an instruction to expand the code matrix to be larger, during or after the process request and the process response. According to another embodiment of the disclosure, the first DAI entity 630-1 may transmit a request to reduce the matrix to be smaller.

The first AMF 640-1 according to an embodiment may identify, based on the process response received from the first DAI entity 630-1, whether to change the size of the code matrix. Here, changing the size of the code matrix may include expanding or reducing the code matrix.

In a case in which the first AMF 640-1 confirms, from the first DAI entity 630-1, that the code matrix is expandable, in operation S1105-1, the first AMF 640-1 may transmit, the first RAN 620-1, a request to expand the code matrix. The request to expand the code matrix according to the disclosure may refer to a request to add terminals to the STBC matrix (e.g., expansion from a G2 matrix to a G4 matrix), and the adding may be operated by performing an update from DAI to AMF. For example, a case in which a G2 matrix is expanded to a G4 matrix may mean that four terminals may perform the cooperative transmission through an update in a situation in which two terminals were performing the cooperative transmission.

In operation S1106-1, the first RAN 620-1 may transmit, to the first terminal 610-1, the request to change the size of the code matrix. In operation S1107-1, the first terminal 610-1 may transmit, to the first RAN 620-1, a response to the request to change the size of the code matrix. The response to the request to change the size of the code matrix according to the disclosure may refer to a response regarding whether each terminal has confirmed the request to change the size of the code matrix. In operation S1108-1, the first RAN 620-1 may transmit, to the first AMF 640-1, the response to the request to change the size of the code matrix. Upon receiving the response to the request to change the size of the code matrix, the first AMF may confirm that a change in the size of the code matrix has been correctly performed.

In operations S1105-2 to S1108-2, the first AMF 640-1 may instruct the second terminal 610-2 to change the size of the code matrix being currently used. Detailed descriptions related to the operations are provided above, and thus will be omitted.

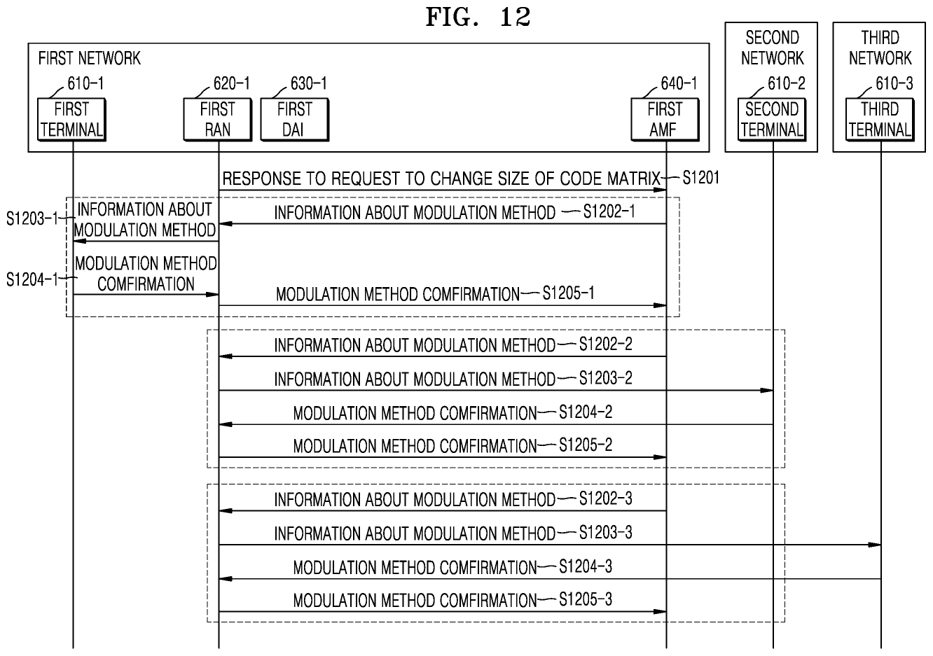

FIG. 12 is a flowchart illustrating data transmission and reception for terminals included in a communication group that is to perform cooperative transmission, in a case in which a code matrix is expanded, according to an embodiment of the disclosure.

Referring to FIG. 12, according to an embodiment of the disclosure, in a case in which the code matrix is expanded, it is necessary to deliver information about a modulation method for a third terminal, which is an additional terminal.

In the case in which the code matrix is expanded according to an embodiment of the disclosure, information about a modulation method indicated for each terminal may be transmitted to all terminals to perform the cooperative transmission, as well as the added terminal.

In operation S1201, the first RAN 620-1 may transmit, to the first AMF 640-1, a response to a request to change the size of the code matrix. The first RAN 620-1 may provide information allocated to each terminal corresponding to each column of the code matrix that has been expanded.

In operations S1202-1 to S1205-1, the first AMF 640-1 may transmit, to the first terminal 610-1, information about a modulation method determined for the first terminal 610-1. In operations S1202-2 to S1205-2, the first AMF 640-1 may transmit, to the second terminal 610-2, information about a modulation method determined for the second terminal 610-2. In operations S1202-3 to S1205-3, the first AMF 640-1 may transmit, to the third terminal 610-3, information about a modulation method determined for the third terminal 610-3. Descriptions of the operations are provided above with reference to FIG. 10, and thus will be omitted.

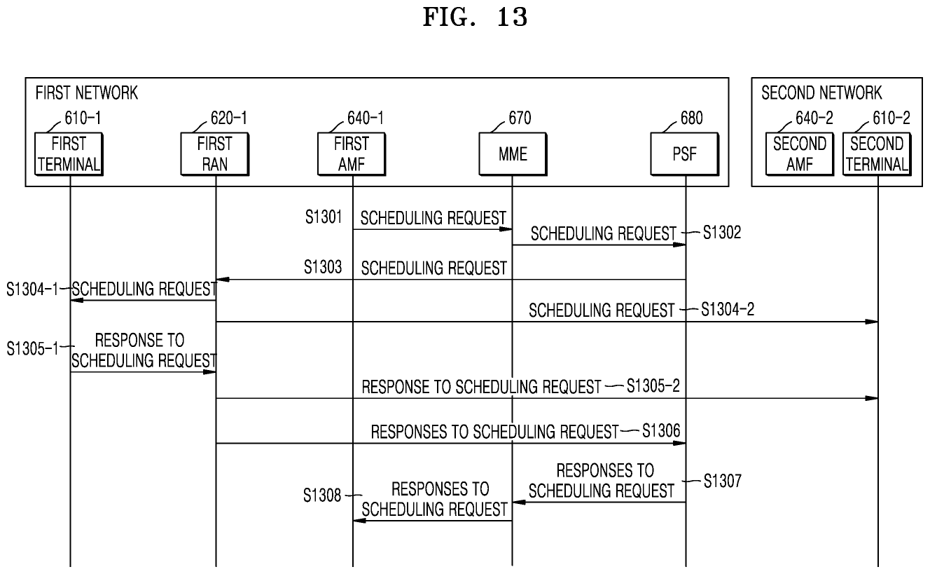

FIG. 13 is a flowchart illustrating data transmission and reception for requesting scheduling for terminals included in a communication group that is to perform cooperative transmission, according to an embodiment of the disclosure.

Referring to FIG. 13, a scheduling request according to the disclosure may refer to a message requesting scheduling for cooperative transmission by interaction between 5G (e.g., an AMF) and 4G (e.g., an MME and a PSF) functional entities. Here, the PSF is a ProSe function, and thus, a RAN may include necessary terminals.

In operation S1301, the first AMF 640-1 may transmit a scheduling request to an MME 670. In operation S1302, the MME 670 may transmit a scheduling request to a PSF 680. In operation S1303, the PSF 680 may transmit the scheduling request to the first RAN 620-1. In operation S1304-1, the first RAN 620-1 may transmit the scheduling request to the first terminal 610-1. In operation S1304-2, the first RAN 620-1 may transmit the scheduling request to the second terminal 610-2. Through the above-described operations, it may be linked with the 4G PS-LTE technology defined by 3GPP. In a case in which the terminals constituting the communication group serve a given remote terminal to which a gNB cannot generally transmit data, it is necessary to determine whether all of the terminals constituting the communication group transmit data in a DL rather than a UL. In addition, similarly, even in a case in which data is transmitted from the remote terminal to the gNB through the communication group of the terminals, scheduling is required.

In operation S1305-1, the first RAN 620-1 may receive, from the first terminal 610-1, a response to the scheduling request. In operation S1305-2, the first RAN 620-1 may receive, from the second terminal, a response to the scheduling request. In operation S1306, the first RAN 620-1 may transmit, to the PSF 680, the responses to the scheduling request. In operation S1307, the PSF 680 may transmit, to the MME 670, the responses to the scheduling request. In operation S1308, the MME 670 may transmit, to the first AMF 640-1, the responses to the scheduling request.

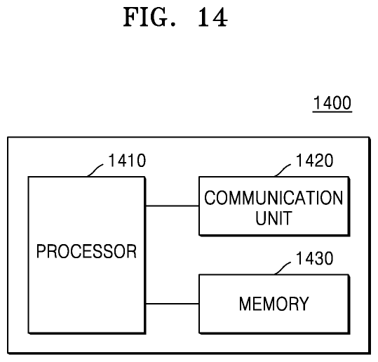

FIG. 14 is a block diagram of an AMF according to an embodiment of the disclosure.

Referring to FIG. 14, for example, an AMF 1400 may refer to the first AMF 510-1 of FIG. 5 or the first AMF 640-1 of FIG. 6. Referring to FIG. 14, the AMF 1400 according to an embodiment may include a processor 1410, a communication unit 1420, and a memory 1430. However, the AMF 1400 may be implemented by more components than all of the components illustrated in FIG. 14.

Although FIG. 14 illustrates that the AMF 1400 includes one processor, the embodiment is not limited thereto, and the AMF 1400 may include a plurality of processors. At least some of the following operations and functions of the processor 1410 may be performed by a plurality of processors. The AMF 1400 illustrated in FIG. 14 may perform operation methods according to various embodiments of the disclosure, and the descriptions provided above with reference to FIGS. 7 to 13 may be applied thereto. Thus, the descriptions provided above will be omitted.

The communication unit 1420 according to an embodiment of the disclosure may perform wired/wireless communication with other entities, a RAN, or a network of a core network. To this end, the communication unit 1420 may include a communication module that supports at least one of various wired/wireless communication methods. For example, the communication module may be in the form of a chipset, or may be a sticker/barcode (e.g., a sticker including a near-field communication (NFC) tag) including information necessary for communication.

The wireless communication may include, for example, at least one of cellular communication, Wireless Fidelity (Wi-Fi), Wi-Fi Direct, Bluetooth, ultra-wideband (UWB), or NFC. The wired communication may include, for example, at least one of Universal Serial Bus (USB) or High-Definition Multimedia Interface (HDMI).

The processor 1410 according to an embodiment of the disclosure controls the overall operation of the AMF 1400, and may include at least one processor, such as a central processing unit (CPU) or a graphics processing unit (GPU). The processor 1410 may control other components included in the AMF 1400 to control communication of a plurality of devices belonging to a communication group. The memory 1430 may store a program for the processor 1410 to perform processing and control, and may store data input to or output from the AMF 1400.

The processor 1410 according to an embodiment of the disclosure may control the communication unit 1420 to request generation of a communication group and receive, from a DAI entity, information about terminals to perform cooperative transmission among a plurality of terminals included in the communication group. The processor 1410 may identify the terminals to perform the cooperative transmission and a modulation method to be requested for each terminal for the cooperative transmission, based on the information about the terminals to perform the cooperative transmission. The processor 1410 may control the communication unit 1420 to request the terminals to perform the cooperative transmission to perform data modulation according to the identified modulation methods, respectively.

The processor 1410 according to an embodiment of the disclosure may invoke the DAI entity. The processor 1410 may control the communication unit 1420 to request, from the DAI entity, information about a code matrix to be used for the cooperative transmission, and receive, from the DAI entity, information about the code matrix indicating the number of terminals to perform the cooperative transmission.

The code matrix according to an embodiment of the disclosure may include an STBC matrix. The processor 1410 may allocate each column of the STBC matrix to each of the terminals to perform the cooperative transmission. The processor 1410 may control the communication unit 1420 to transmit, to a base station, column allocation information indicating execution of data modulation according to modulation methods respectively indicated by the columns allocated to the terminals to perform the cooperative transmission.

The information about the terminals to perform the cooperative transmission according to an embodiment of the disclosure may include information about terminals selected based on the code matrix, and the selected terminals may be terminals included in a plurality of overlapping networks to perform the cooperative transmission.

The processor 1410 according to an embodiment of the disclosure may obtain a PCF ID of a PCF for a terminal connected to another network. The processor 1410 may control the communication unit to transmit, to the terminal, participation request information for a new group by using the PCF ID. The processor 1410 may generate the communication group with the terminal, based on a response to the participation request information.

The processor 1410 according to an embodiment of the disclosure may instantiate, as a H-PCF, the PCF for the terminal connected to the other network, by using the PCF ID. The processor 1410 may instantiate, as a V-PCF, a PCF included in the same network as the AMF. The processor 1410 may control the communication unit 1420 to transmit, to the V-PCF, participation request information for the communication group. The participation request information for the communication group may be transmitted from the V-PCF to the H-PCF, and then transmitted to the terminal.

The processor 1410 according to an embodiment of the disclosure may control the communication unit 1420 to transmit a logical attachment request to at least one terminal, which is connected to the other network and has accepted a request to participate in the communication group. The processor 1410 may request handover from the at least one terminal, based on a response to the logical attachment request. A base station included in the same network as the AMF 1400 may be physically attached to the at least one terminal, which is connected to the other network and has accepted the request to participate in the communication group.

The processor 1410 according to an embodiment of the disclosure may control the communication unit 1420 to receive, from another DAI entity included in another network, information of the other DAI entity including information about a code matrix performed by the other DAI entity and information about terminals. The processor 1410 may control the communication unit 1420 to transmit, to the DAI entity included in the same network as the AMF 1400, the information of the other DAI entity. The processor 1410 may control the communication unit 1420 to receive, from the DAI entity, information for instructing to change the size of the code matrix, based on the information of the other DAI entity. The processor 1410 may control the communication unit 1420 to transmit, to the base station, the information for instructing to change the size of the code matrix, based on the information for instructing to change the size of the code matrix.

The processor 1410 according to an embodiment of the disclosure may control the communication unit 1420 transmit, to the base station, a scheduling request for the cooperative transmission for the terminals to perform the cooperative transmission. The processor 1410 may control the communication unit to transmit a scheduling request to an MME. The scheduling request may be transmitted from the MME to a PSF, and then transmitted from the PSF to the base station. The description provided above with reference to FIGS. 7 to 13 may be applied to a detailed method, performed by the processor 1410, of controlling communication of a plurality of devices belonging to a communication group, and thus, the description thereof will be omitted.

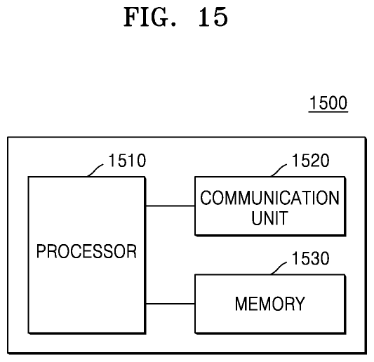

FIG. 15 is a block diagram of a DAI entity according to an embodiment of the disclosure.

Referring to FIG. 15, for example, a DAI entity 1500 may refer to the first DAI entity 630-1 of FIG. 6. Referring to FIG. 15, the DAI entity 1500 according to an embodiment may include a processor 1510, a communication unit 1520, and a memory 1530. However, the DAI entity 1500 may be implemented by more components than all of the components illustrated in FIG. 15.

Although FIG. 15 illustrates that the DAI entity 1500 includes one processor, the embodiment is not limited thereto, and the DAI entity 1500 may include a plurality of processors. At least some of the following operations and functions of the processor 1510 may be performed by a plurality of processors. The DAI entity 1500 illustrated in FIG. 15 may perform operation methods according to various embodiments of the disclosure, and the descriptions provided above with reference to FIGS. 7 to 13 may be applied thereto. Thus, the descriptions provided above will be omitted.

The communication unit 1520 according to an embodiment of the disclosure may perform wired/wireless communication with the AMF 1400 or other DAI entities. To this end, the communication unit 1520 may include a communication module that supports at least one of various wired/wireless communication methods. For example, the communication module may be in the form of a chipset, or may be a sticker/barcode (e.g., a sticker including an NFC tag) including information necessary for communication.

The wireless communication may include, for example, at least one of cellular communication, Wi-Fi, Wi-Fi Direct, Bluetooth, UWB, or NFC. The wired communication may include, for example, at least one of USB or HDMI.

The processor 1510 according to an embodiment of the disclosure controls the overall operation of the DAI entity 1500, and may include at least one processor, such as a CPU or a GPU. The processor 1510 may control other components included in the DAI entity 1500. The memory 1530 may store a program for the processor 1510 to perform processing and control, and may store data input to or output from the DAI entity 1500.

The description provided above with reference to FIGS. 7 to 13 may be applied to a detailed operation method of the processor 1510, and thus, the description thereof will be omitted.

Meanwhile, the above-described embodiments may be written as a computer-executable program, and may be implemented in a general-purpose digital computer that executes the program by using a computer-readable recording medium. In addition, the structure of the data used in the above-described embodiments may be recorded in a computer-readable recording medium through various units. In addition, the above-described embodiments may be implemented in the form of a computer program product including computer-executable instructions, such as a computer-executable program module. For example, the methods implemented as software modules or algorithms may be stored on a computer-readable recording medium, as computer-readable and computer-executable code or program commands.

The computer-readable medium may be any recording medium that is accessible by a computer, and may include a volatile or non-volatile medium and a removable or non-removable medium. The computer-readable recording medium may include, but is not limited to, a magnetic storage medium, such as read-only memory (ROM), a floppy disk, or a hard disk, and an optical storage medium, such as a compact disc ROM (CD-ROM) or a digital video disc (DVD). Also, the computer-readable medium may include a computer storage medium and a communication medium.

In addition, a plurality of computer-readable recording media may be distributed in networked computer systems, and data stored in the distributed recording media, for example, program instructions and code, may be executed by at least one computer.

A machine-readable storage medium may be provided in the form of a non-transitory storage medium. Here, the term ‘non-transitory storage medium’ merely means that the storage medium does not refer to a transitory electrical signal but is tangible, and does not distinguish whether data is stored semi-permanently or temporarily on the storage medium. For example, the non-transitory storage medium may include a buffer in which data is temporarily stored.

According to an embodiment of the disclosure, the methods according to various embodiments may be included in a computer program product and then provided. The computer program products may be traded as commodities between sellers and buyers.

The computer program product may be distributed in the form of a machine-readable storage medium (e.g., a CD-ROM), or may be distributed online (e.g., downloaded or uploaded) through an application store (e.g., Play Store™) or directly between two user devices (e.g., smart phones). In a case of online distribution, at least a portion of the computer program product (e.g., a downloadable app) may be temporarily stored in a machine-readable storage medium, such as a manufacturer's server, an application store's server, or a memory of a relay server.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method, performed by an access and mobility management function (AMF), of controlling communication of a plurality of terminals belonging to a communication group in a wireless communication system, the method comprising:
requesting generation of the communication group;
receiving, from a distributed artificial intelligence entity, information about terminals that are to perform cooperative transmission among the plurality of terminals included in the communication group;
identifying, based on the information about the terminals that are to perform the cooperative transmission, the terminals that are to perform the cooperative transmission and modulation methods to be requested for the terminals that are to perform the cooperative transmission, for the cooperative transmission; and
requesting the terminals that are to perform the cooperative transmission, to perform data modulation according to the modulation methods.

2. The method of claim 1, further comprising:
invoking the distributed artificial intelligence entity;
requesting, from the distributed artificial intelligence entity, information about a code matrix to be used for the cooperative transmission; and
receiving, from the distributed artificial intelligence entity, the information about the code matrix indicating a number of terminals that are to perform the cooperative transmission.

3. The method of claim 2,
wherein the code matrix comprises a space-time block code (STBC) matrix,
wherein the identifying, based on the information about the terminals that are to perform the cooperative transmission, of the terminals that are to perform the cooperative transmission and the modulation methods to be requested for the terminals that are to perform the cooperative transmission, respectively, for the cooperative transmission, comprises allocating each column of the STBC matrix to each of the terminals to perform the cooperative transmission, and
wherein the requesting of the terminals that are to perform the cooperative transmission, to perform the data modulation according to the modulation methods, respectively, comprises transmitting, to a base station, column allocation information indicating execution of the data modulation according to modulation methods that are indicated by the columns allocated to the terminals that are to perform the cooperative transmission, respectively.

4. The method of claim 2,
wherein the information about the terminals that are to perform the cooperative transmission comprises information about terminals selected based on the code matrix, and
wherein the selected terminals are terminals included in a plurality of overlapping networks to perform the cooperative transmission.

5. The method of claim 1, wherein the requesting of the generation of the communication group comprises:
obtaining a policy control function (PCF) identification (ID) of a PCF for a terminal connected to another network;
transmitting, to the terminal, participation request information for the communication group by using the PCF ID; and
generating the communication group with the terminal, based on a response to the participation request information.

6. The method of claim 5,
wherein the transmitting, to the terminal, of participation request information for the communication group by using the PCF ID comprises:
instantiating, as a Home-PCF, the PCF for the terminal connected to the other network, by using the PCF ID,
instantiating, as a Visited-PCF, a PCF included in a network including the AMF, and
transmitting, to the Visited-PCF, participation request information for the communication group, and
wherein the participation request information for the communication group is transmitted from the Visited-PCF to the Home-PCF, and then transmitted to the terminal.

7. The method of claim 1, wherein the requesting of the generation of the communication group comprises:
transmitting a logical attachment request to at least one terminal, which is connected to another network and has accepted a request to participate in the communication group; and
requesting handover from the at least one terminal, based on a response to the logical attachment request.

8. The method of claim 1, wherein a base station included in a network including the AMF is physically attached to at least one terminal, which is connected to another network and has accepted a request to participate in the communication group.

9. The method of claim 1, further comprising:
receiving, from another distributed artificial intelligence entity included in another network, information of the other distributed artificial intelligence entity including information about a code matrix performed by the other distributed artificial intelligence entity and information about terminals;
transmitting the information of the other distributed artificial intelligence entity to the distributed artificial intelligence entity included in the network including the AMF;
based on the information of the other distributed artificial intelligence entity, receiving, from the distributed artificial intelligence entity, information for instructing to change a size of a code matrix; and
based on the information for instructing to change the size of the code matrix, transmitting, to a base station, the information for instructing to change the size of the code matrix.

10. The method of claim 1, further comprising:
transmitting, to a base station, a scheduling request for the cooperative transmission for the terminals that are to perform the cooperative transmission,
wherein the transmitting of the scheduling request to the base station comprises transmitting the scheduling request to a mobility management entity (MME), and
wherein the scheduling request is transmitted from the MME to a proximity services function (PSF), and then transmitted from the PSF to the base station.

11. An access and mobility management function (AMF) for controlling communication of a plurality of terminals belonging to a communication group, the AMF comprising:
a communication unit; and
at least one processor coupled to the communication unit,
wherein the at least one processor is configured to:
request generation of the communication group,
control the communication unit to receive, from a distributed artificial intelligence entity, information about terminals that are to perform cooperative transmission among the plurality of terminals included in the communication group,
identify, based on the information about the terminals that are to perform the cooperative transmission, the terminals that are to perform the cooperative transmission and modulation methods to be requested for the terminals that are to perform the cooperative transmission, for the cooperative transmission, and
request the terminals that are to perform the cooperative transmission, to perform data modulation according to the modulation methods.

12. The AMF of claim 11, wherein the at least one processor is further configured to:
invoke the distributed artificial intelligence entity, and control the communication unit to request, from the distributed artificial intelligence entity, information about a code matrix to be used for the cooperative transmission, and
receive, from the distributed artificial intelligence entity, the information about the code matrix indicating a number of terminals that are to perform the cooperative transmission.

13. The AMF of claim 11, wherein the at least one processor is further configured to:
obtain a policy control function (PCF) identification (ID) of a PCF for a terminal connected to another network,
control the communication unit to transmit, to the terminal, participation request information for the communication group by using the PCF ID, and
generate the communication group with the terminal, based on a response to the participation request information.

14. The AMF of claim 11,
wherein the at least one processor is further configured to:
control the communication unit to transmit a logical attachment request to at least one terminal, which is connected to another network and has accepted a request to participate in the communication group, and
request handover from the at least one terminal, based on a response to the logical attachment request, and
wherein a base station included in a network including the AMF is physically attached to at least one terminal, which is connected to another network and has accepted a request to participate in the communication group.

15. The AMF of claim 11, wherein the at least one processor is further configured to:
control the communication unit to receive, from another distributed artificial intelligence entity included in another network, information of the other distributed artificial intelligence entity including information about a code matrix performed by the other distributed artificial intelligence entity and information about terminals,
control the communication unit to transmit the information of the other distributed artificial intelligence entity to the distributed artificial intelligence entity included in the network including the AMF,
control the communication unit to, based on the information of the other distributed artificial intelligence entity, receive, from the distributed artificial intelligence entity, information for instructing to change a size of a code matrix, and
control the communication unit to, based on the information for instructing to change the size of the code matrix, transmit, to a base station, the information for instructing to change the size of the code matrix.
